(19) United States
(12) Patent Application Publication
(10) Pub. No.: US 2023/0413787 A1
(43) Pub. Date: Dec. 28, 2023

(54) REARING SYSTEMS FOR KEEPING FARM ANIMALS, IN PARTICULAR POULTRY ANIMALS, AND RELATED FARM ANIMAL SHED

(71) Applicant: BIG DUTCHMAN INTERNATIONAL GMBH, Vechta (DE)

(72) Inventors: Jorg Kuking, Hopsten (DE); Nils Neugebauer, Rastede (DE)

(73) Assignee: BIG DUTCHMAN INTERNATIONAL GMBH, Vechta (DE)

(21) Appl. No.: 18/367,567

(22) Filed: Sep. 13, 2023

(51) Int. Cl. A01K 31/22; A01K 1/00

(52) U.S. Cl. CPC A01K 31/22; A01K 1/0047

(57) ABSTRACT

A rearing system for keeping farm animals, in particular poultry animals. The rearing system having at least one light source for illuminating the animal bodies of the farm animals with light, wherein the at least one light source is designed as a UV-B light source which is configured to emit UV-B light onto the animal bodies.

### FIELD OF THE INVENTION

The invention relates to a rearing system for keeping farm animals, in particular poultry animals. The invention further relates to a farm animal shed, a use, as well as a method.

### BACKGROUND OF THE INVENTION

Rearing systems of the type described at the beginning are known from the prior art. They are used, for example, for keeping laying hens for the purpose of egg production and often have grid floors which are designed, for example, as wire floors, and are coarsely meshed and often inclined. Due to the inclination of the grid floor, system eggs roll off so that they can be collected by hand. Such rearing systems are often located in an at least partially closed shed building so that the poultry animals have no or only limited contact with natural sunlight. In this context, it has been observed that the meat quality or the shells of the eggs produced from poultry animals can experience quality degradation due to the lack of sunlight exposure.

Against this background, it was the object of the invention to further develop a rearing system of the type mentioned above in such a manner that the disadvantages found in the prior art are eliminated as far as possible. In particular, a rearing system was to be proposed which has a positive influence on the health of the poultry animals as well as the meat quality and the quality of the eggshells of the eggs produced.

### SUMMARY OF THE INVENTION

According to the invention, the object is achieved with a rearing system of the type mentioned at the beginning in that the rearing system has at least one light source for illuminating the bodies of the farm animals with light, wherein the at least one light source is designed as a UV-B light source which is configured to emit UV-B light onto the animal body.

The invention is based on the finding that by arranging a UV-B light source in the rearing system, which specifically illuminates the animal bodies with UV-B light, a production of vitamin D in the animal bodies can be stimulated. As a result, the quality of the meat as well as the texture of the egg shell can be improved. Surprisingly, it has also been shown that illumination with UV-B light can further reduce the probability of occurrence of sternum damage in poultry animals. Thus, illuminating the animals with UV-B light has a positive effect on animal welfare and animal health. Preferably, the light source is arranged in the rearing system in such a manner that the UV-B light is emitted to sparsely covered portions of the animal body, for example to the skin or legs of the poultry animals, which are referred to as shanks.

According to one embodiment, the UV-B light source emits light in a wavelength range of 280 nanometers to 315 nanometers. UV-B light of the aforementioned wavelength has been shown to be particularly suitable for stimulating vitamin D production in the animal body. According to one embodiment, the UV-B light source emits light exclusively in the mentioned wavelength range. According to an alternative embodiment, the UV-B light source emits light in a broader spectrum, but also in the UV-B range. According to one embodiment, the rearing system has multiple light sources which are designed as UV-B light sources.

According to one embodiment, the rearing system has at least one floor, in particular a grid floor, for accommodating the poultry animals, wherein at least one UV-B light source is configured to irradiate the poultry animals kept on the floor in the region of the shanks of the poultry animals. This can be done in particular by a targeted arrangement of the UV-B light source in a region adjacent to or directed towards the shank region of the poultry animals. In this manner, the UV light can penetrate the skin at parts of the poultry body with little hair or feathers and, to this extent, stimulate vitamin D production in the animal body.

According to one embodiment, the rearing system has a foot rail, wherein at least one UV-B light source is arranged on the foot rail. The poultry animals often come to a halt on the foot rail in the rearing system. Thus, it is also known in which region the shanks of the animals are typically positioned, so that this region can be illuminated in a targeted manner.

According to one embodiment, the rearing system has an air duct which extends in particular below the floor and wherein at least one UV-B light source is arranged on the air duct and is configured to emit light through openings in the floor in the direction of the poultry animals. In this manner, it can be achieved that an UV-B light source arranged in such a manner is protected from contamination and, at the same time, UV-B light is emitted to an underside of the animal body, in particular the region of the shanks.

According to one embodiment, the rearing system has a separating grid for separating living areas, wherein at least one UV-B light source is arranged on the separating grid. The separating grid has proven to be another particularly suitable installation option for the UV-B light source since the positioning of the UV-B light source on the separating grid also allows targeted irradiation of the desired animal body areas.

According to one embodiment, the rearing system comprises a feed trough, wherein at least one UV-B light source is arranged on the feed trough. The UV-B light source can be designed, for example, as a light strip and emit light, in particular downwards. By such an arrangement of the UV-B light source, in particular the shank region of the animals can be irradiated with UV light, which in turn is advantageous for stimulating a vitamin D production in the animal body.

According to one embodiment, the rearing system comprises a perch in which a cavity is formed in which at least one UV-B light source is arranged, wherein the perch is formed from a material that is at least partially permeable to UV-B light, in particular from a transparent material. The UV-B light source can be designed, for example, as a light tube. Due to the arrangement of the light source in the perch, the shanks of the animals on the perch are illuminated with UV-B light in a particularly targeted manner. Preferably, the perch is made of plastics. According to one embodiment, the perch provided with a UV-B light source is arranged outside the rearing system.

According to one embodiment, at least one UV-B light source is arranged on an outer face of the rearing system, wherein the light source is configured to emit UV-B light in the direction of an adjacent rearing system. In this manner, the UV-B light can be emitted over a large area to an adjacent rearing system and thus rearing systems which themselves do not have a UV-B light source, or animal living areas between adjacent rearing systems, can also be illuminated with the UV-B light in question.

According to one embodiment, the rearing system has a group cage or an aviary or is designed as a group cage or an aviary. Such group cage housing or aviary housing has proved particularly suitable for egg laying of poultry animals.

The invention has been described above with reference to a rearing system. In another aspect, the invention relates to a farm animal shed for keeping farm animals, in particular poultry animals. The invention achieves the object described at the beginning with reference to the farm animal shed in that the farm animal shed comprises a rearing system according to at least one of the above exemplary embodiments. The farm animal shed makes use of the same advantages and preferred embodiments as the rearing system according to the invention and vice versa. In this regard, reference is made to the embodiments above and the contents thereof are hereby incorporated. In particular, the use of a rearing system according to the invention for a farm animal shed of closed construction has been shown to stimulate vitamin D production in the animal body despite the lack of or limited exposure to sunlight.

In another aspect, the invention relates to the use of a rearing system according to at least one of the above examples of keeping farm animals, in particular poultry animals, in a farm animal shed, preferably in a farm animal shed according to the above exemplary embodiment. The use also makes use of the same advantages and preferred embodiments as the rearing system according to the invention, the animal farm shed according to the invention and vice versa. In this regard, reference is made to the embodiments above and the contents thereof are hereby incorporated.

In another aspect, the invention relates to a method for illuminating farm animals, in particular poultry animals, by means of a rearing system according to any one of the preceding claims, the method comprising the steps of: Illuminating the farm animals with UV-B light, in particular in the region of the shanks of the farm animals, wherein the illumination is carried out continuously or discontinuously. The method also makes use of the same advantages and preferred embodiments as the rearing system according to the invention, the animal farm shed according to the invention and the use according to the invention. In this regard, reference is made to the embodiments above and the contents thereof are hereby incorporated. By providing continuous or discontinuous lighting to farm animals, overall animal welfare can be improved. Since some farm animal species can perceive UV light optically, it can be effective, depending on the application, to carry out the illumination with UV-B light not permanently, i.e. continuously, but discontinuously, for example during individual defined periods or, for example, exclusively during the day or the like. In this manner, it can be ensured that the behavior of the farm animals does not change or changes only slightly as a result of the illumination with UV-B light.

Further features and advantages of the invention are apparent from the appended claims and the following description, in which exemplary embodiments are explained in detail with reference to schematic drawings.

### BRIEF DESCRIPTION OF THE DRAWINGS

In the Figures:

FIG. 1 shows a first exemplary embodiment of a rearing system according to the invention in a sectional view; and

FIG. 2 shows a second exemplary embodiment of a rearing system according to the invention in a sectional view.

### DETAILED DESCRIPTION OF THE EMBODIMENTS

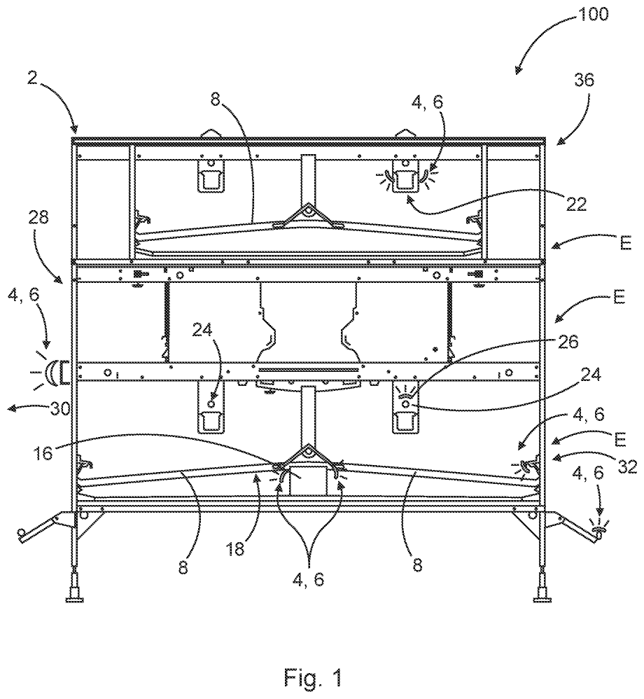

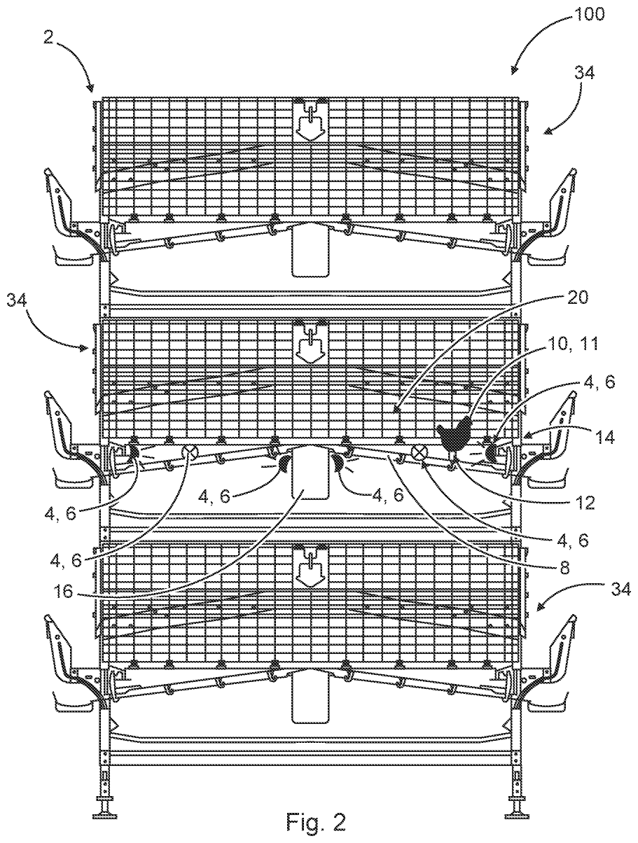

FIG. 1 shows a rearing system 2 for keeping farm animals 10, in particular poultry animals 10. The rearing system 2 is arranged in a schematically indicated farm animal shed 100. In the present case, the rearing system 2 has three levels E, wherein appropriately inclined floors 8 are provided in a lower level E for accommodating poultry animals 10. Furthermore, such an inclined floor 8 is also shown in an upper level E of the rearing system 2. The rearing system 2 has multiple light sources 4 for illuminating the animal bodies of the farm animals (not shown in FIG. 1) with light. The light sources 4 are designed as UV-B light sources 6, each of which is configured to emit UV-B light onto the animal body. FIGS. 1 and 2 show, by way of example, different installation locations for the UV-B light sources 6. A rearing system 2 can basically comprise all or only some or a single one of the UV-B light sources 6.

In the exemplary embodiment shown in FIG. 1, the rearing system 2 has an air duct 16. In particular, the air duct 16 extends below the floor 8. A UV-B light source 6 is arranged on the air duct 16 and configured to emit light through openings 18 in the floor 8 in the direction of poultry animals kept on the floor 8. In this manner, the UV-B light source 6 is protected from contamination and at the same time it is achieved that the poultry animals are illuminated with UV-B light in the area of their legs, i.e. their shanks. The rearing system 2 further comprises a feed trough 22. At least one UV-B light source 6 is arranged on the feed trough 22.

Moreover, the rearing system 2 includes perches 24. A cavity 26 is formed in each of the perches 24. At least one UV-B light source 6 is arranged in the cavity 26. The UV-B light source 6 can be formed, for example, as a light strip. The perch 24 is formed from a material that is at least partially permeable to UV-B light, in particular from a transparent material, so that the UV-B light can be emitted from the cavity 26 of the perch 24 in the direction of the poultry animals. The rearing system 2 further comprises an outer face 28. At least one UV-B light source 6 is arranged on the outer face 28 of the rearing system 2, which is in particular configured to emit UV-B light in the direction of an adjacent rearing system 30. In this manner, an adjacent rearing system 30 which does not have any UV-B light sources 6 can also be illuminated with UV-B light. The rearing system 2 further comprises a sheet metal perch 32. At least one UV-B light source 6 is arranged at the sheet metal perch 32 so that a targeted illumination of the shanks of the farm animals is also made possible here. In the exemplary embodiment shown in FIG. 1, the rearing system 2 is designed as an aviary 36.

FIG. 2 shows a schematically illustrated farm animal shed 100 with a rearing system 2 which includes group cages 34. The rearing system 2 has multiple light sources 4 for illuminating the animal bodies 11 of the farm animals 10 with light, wherein the light source 4 is designed as a UV-B light source 6. The UV-B light source 6 is configured to emit UV-B light onto the animal body 11. In particular, the light emitted by the UV-B light source 6 has a wavelength range of 280 nanometers to 315 nanometers. The rearing system 2 has at least one floor 8, in particular a grid floor 8 for accommodating the poultry animals 10. At least one UV-B light source 6 is configured to irradiate the poultry animals 10 kept on the floor 8 in the region of the shanks 12 of the poultry animals 10.

Furthermore, the rearing system 2 shown in FIG. 2 comprises a foot rail 14. At least one UV-B light source 6 is arranged on the foot rail 14. The arrangement makes use of the fact that a farm animal 10, shown as an example in FIG. 2, with an animal body 11 is illuminated in the region of its shanks with UV light by the UV-B light source 6 which is arranged at the foot rail 14. The rearing system 2 shown in FIG. 2 further comprises a separating grid 20 for separating living areas. At least one UV-B light source 6 is arranged on the separating grid 20, so that the poultry animals 10 can also be illuminated here.

The embodiment shown in FIG. 2 also has an air duct 16. The air duct 16 extends below the floor 8. A UV-B light source 6 is arranged on the air duct 16 and aligned in such a manner that light can be emitted in the direction of the poultry animals 10 through openings in the floor 8, which are not shown in FIG. 2.

The invention claimed is as follows:

1. A rearing system for keeping farm animals, in particular poultry animals,
characterized in that the rearing system has at least one light source for illuminating the animal bodies of the farm animals with light, wherein the at least one light source is designed as a UV-B light source which is configured to emit UV-B light onto the animal bodies.

2. The rearing system according to claim 1, wherein the UV-B light source emits light in a wavelength range of 280 nanometers to 315 nanometers.

3. The rearing system according to claim 1, wherein the rearing system has at least one floor, in particular a grid floor, for accommodating the poultry animals, and wherein at least one UV-B light source is configured to irradiate the poultry animals kept on the floor in the region of the shanks of the poultry animals.

4. The rearing system according to claim 1, wherein the rearing system comprises a foot rail, and wherein at least one UV-B light source is arranged on the foot rail.

5. The rearing system according to claim 3, wherein the rearing system comprises:
an air duct which extends in particular below the floor; and
wherein at least one UV-B light source is arranged on the air duct and is configured to emit light through openings in the floor in the direction of the poultry animals.

6. The rearing system according to claim 1, wherein the rearing system comprises a separating grid for separating living areas, and wherein at least one UV-B light source is arranged on the separating grid.

7. The rearing system according to claim 1, wherein the rearing system comprises a feed trough and wherein at least one UV-B light source is arranged on the feed trough.

8. The rearing system according to claim 1, wherein the rearing system further comprises:
a perch in which a cavity is formed in which at least one UV-B light source is arranged;
wherein the perch is formed from a material which is at least partially transparent to UV-B light, in particular from a transparent material.

9. The rearing system according to claim 1, wherein at least one UV-B light source is arranged on an outer face of the rearing system and is configured to emit UV-B light in the direction of an adjacent rearing system.

10. The rearing system according to claim 1, wherein the rearing system comprises a sheet metal perch and wherein at least one UV-B light source is arranged on the sheet metal perch.

11. The rearing system according to claim 1, wherein the rearing system comprises a group cage or an aviary or is designed as a group cage or aviary.

12. A farm animal shed for keeping farm animals, in particular poultry animals, comprising a rearing system according to claim 1.

13. A use of a rearing system according to claim 1 for keeping farm animals, in particular poultry animals, in a farm animal shed, preferably in a farm animal shed.

14. A method for illuminating farm animals in particular poultry animals, by means of a rearing system according to claim 1, the method comprising the steps of:
illuminating the farm animals with UV-B light, in particular in the region of the shanks or further body parts of the farm animals, wherein the illumination is carried out continuously or discontinuously.
